(19) United States
(12) Patent Application Publication
(10) Pub. No.: US 2024/0331586 A1
(43) Pub. Date: Oct. 3, 2024

(54) Sugar Skull Shape LED Lamp and Sign

(71) Applicant: Anthony Raul Escamilla, Milwaukee, WI (US)

(72) Inventor: Anthony Raul Escamilla, Milwaukee, WI (US)

(21) Appl. No.: 18/194,888

(22) Filed: Apr. 3, 2023

(51) Int. Cl. G09F 13/04

(52) U.S. Cl. CPC G09F 13/0404; G09F 13/0445; G09F 13/0481

(57) ABSTRACT

The skull shape signage/lamp device in which the inside housing having a plurality of spaced-apart LED light sources mounted on acrylic behind the front skull shape (2). When power is supplied, the LED lights provide direct illumination to the observer, and also diffuse light throughout the front acrylic skull shape, providing background illumination of the vibrant colors, with improved field of vision (1).

The present invention relates to LED signage and lamp device. More particularly, the present invention relates to illuminated signage devices for displaying logos and symbols.

### BACKGROUND OF THE INVENTION

Sugar Skull Shape LED illuminated signs/lamps are important devices used to display trademark logos and symbols, for Commercial Companies and Sport Teams.

Signs take on different forms, but with Sugar Skull Shape LED illuminated lamp/signs provide vibrant color and detail designs that attract the attention of prospective customers.

### DESCRIPTION

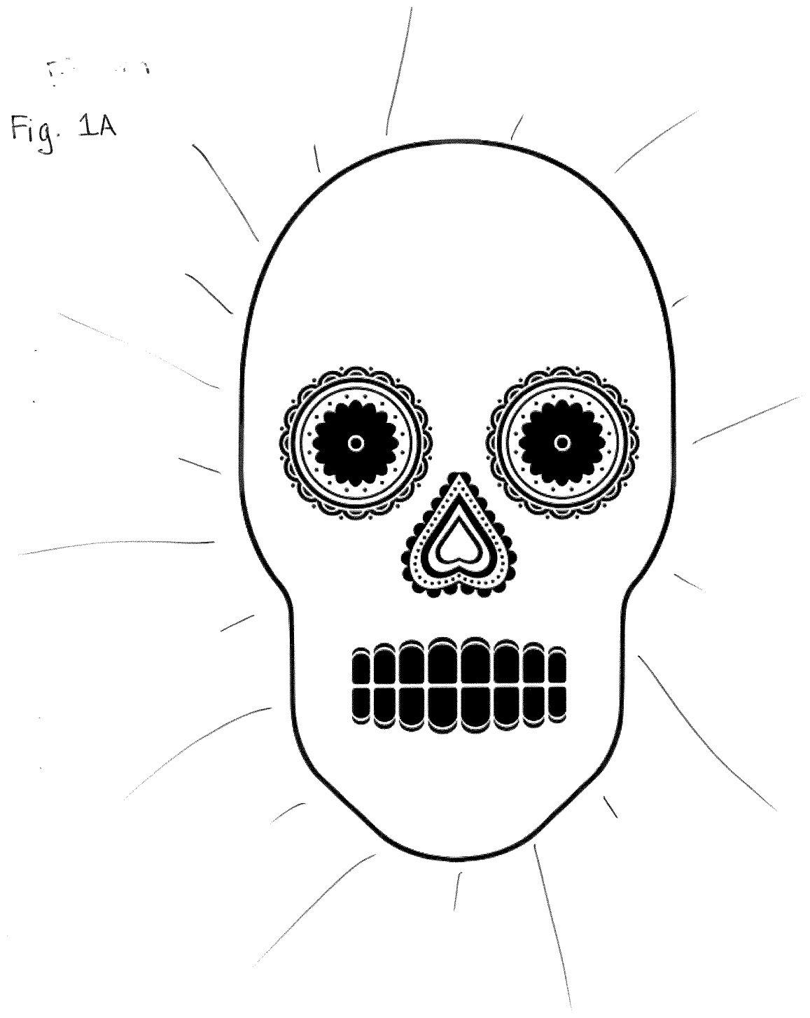

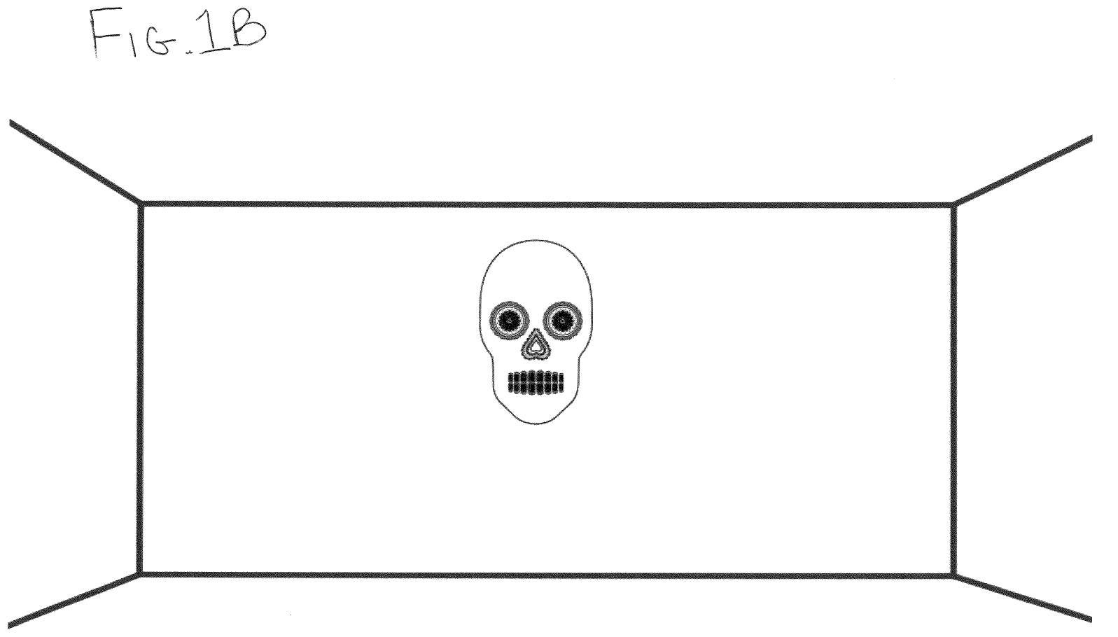

FIG. 1A front view thereof, wherein the outward radiating lines represent the light being on

FIG. 1B is a perspective view of the lamp/signage device according to the present invention mounted inside, on a business wall, wherein the outward radiating lines represent the light being on

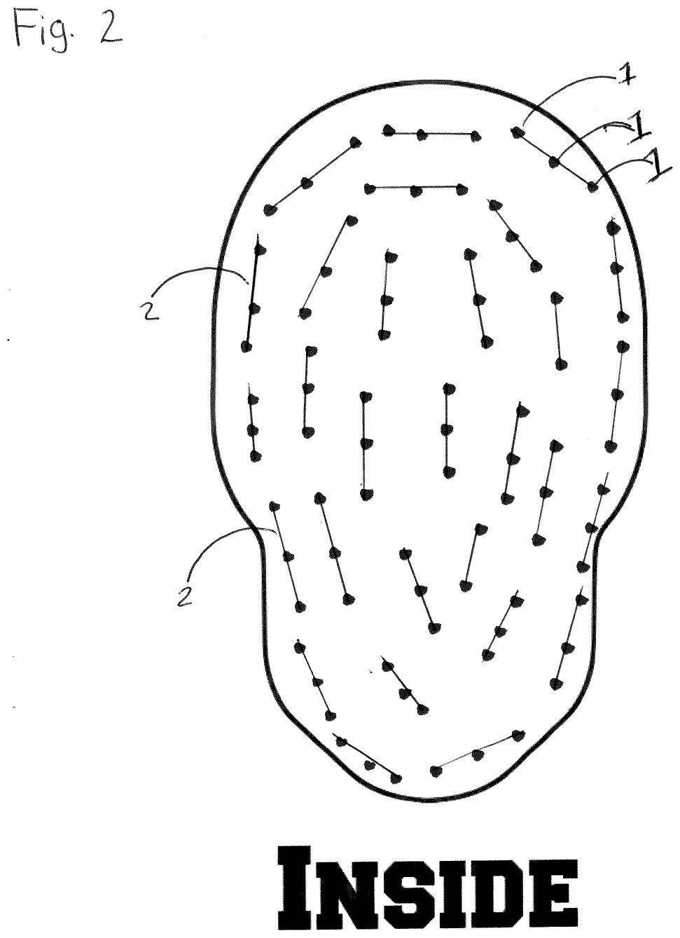

FIG. 2 Inside view thereof

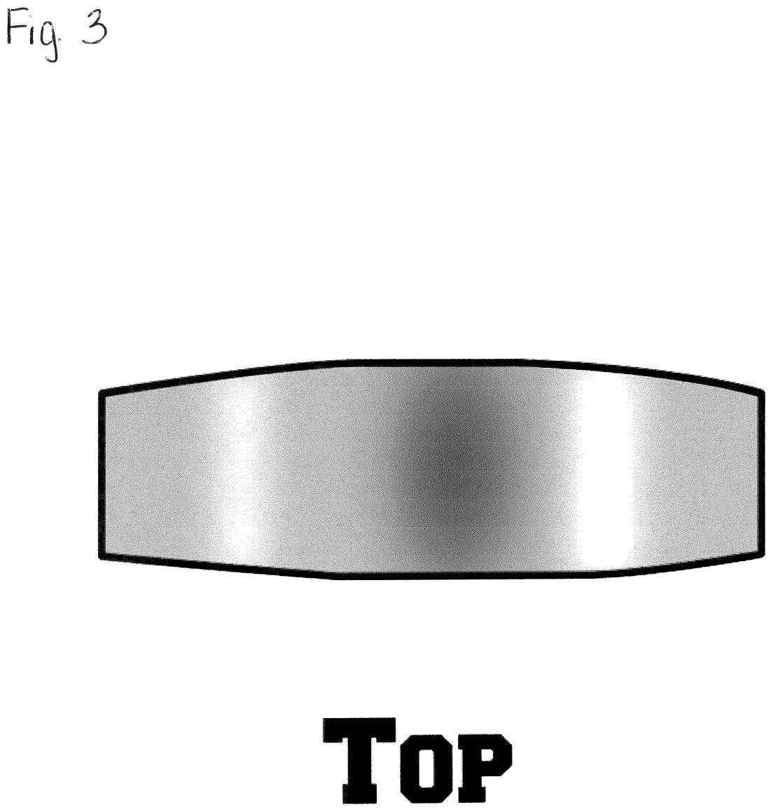

FIG. 3 Top view thereof

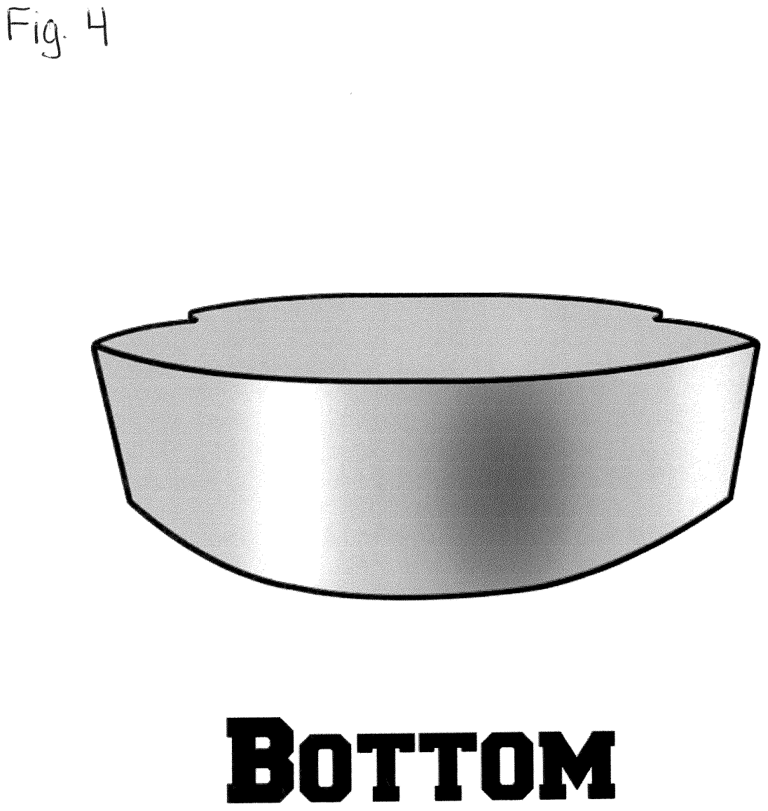

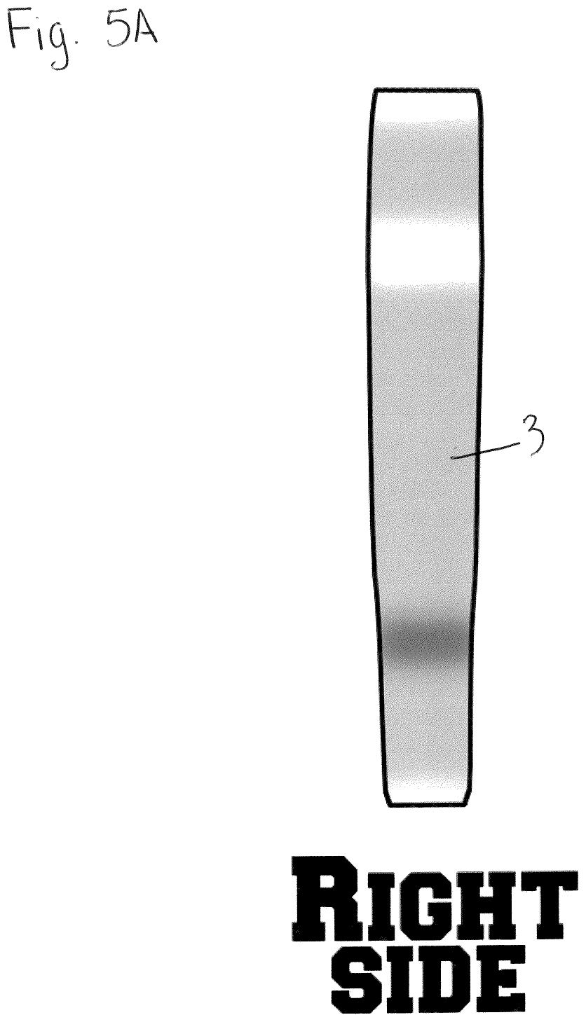

FIG. 4 Bottom view thereof

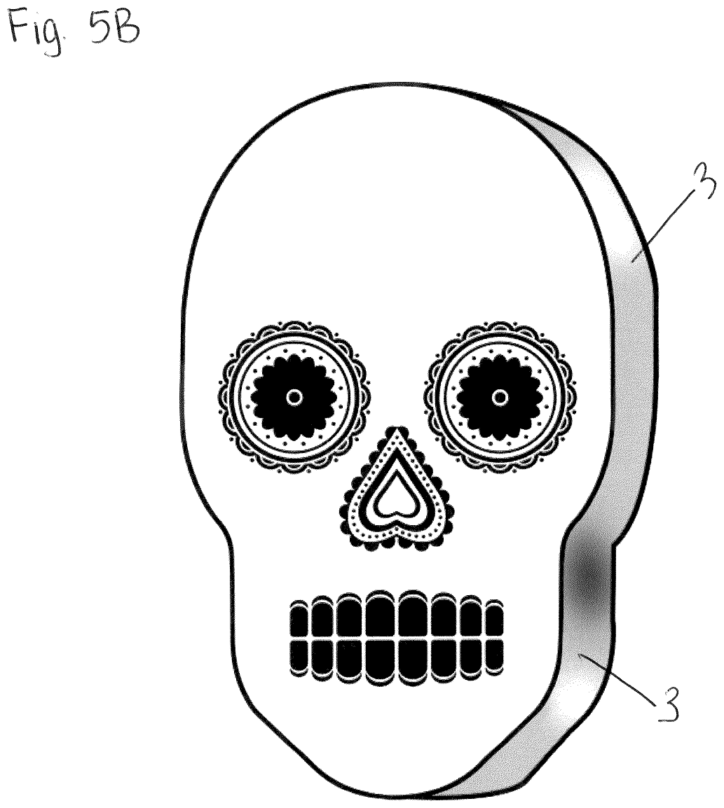

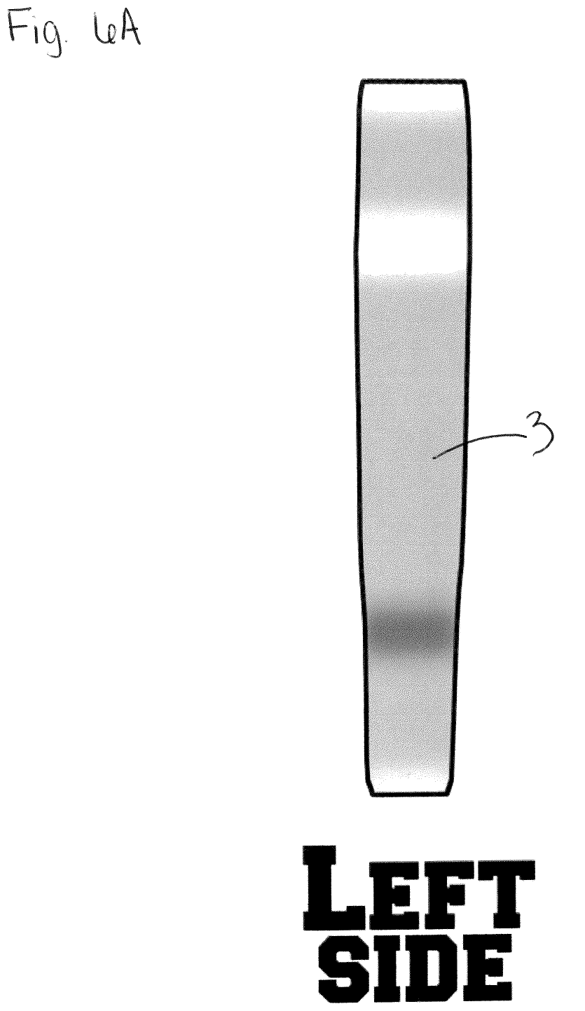

FIG. 5A Right Side view thereof

FIG. 5B Right Side view thereof

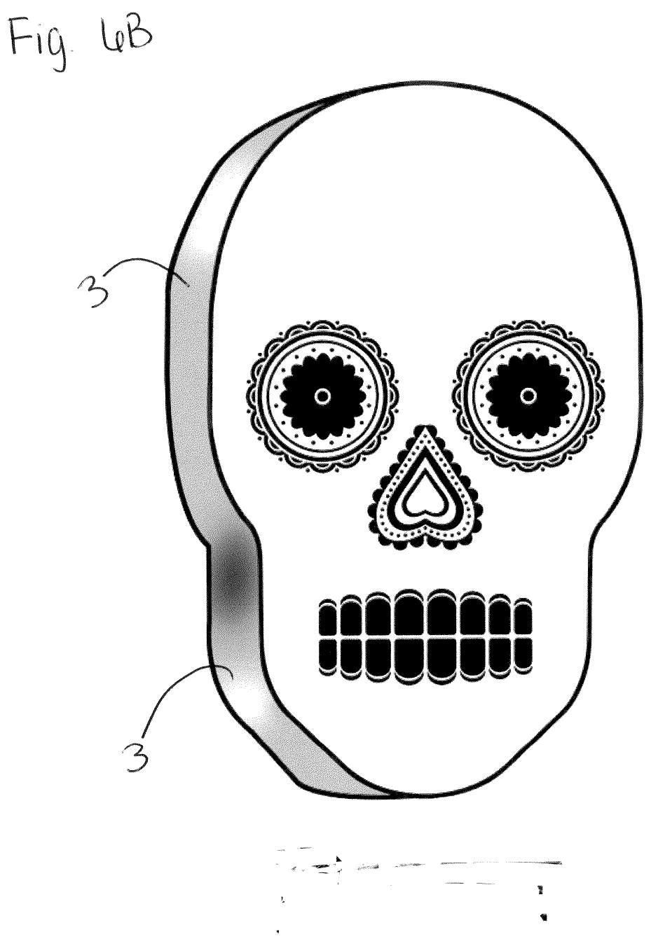

FIG. 6A Left Side view thereof

FIG. 6B Left Side view thereof

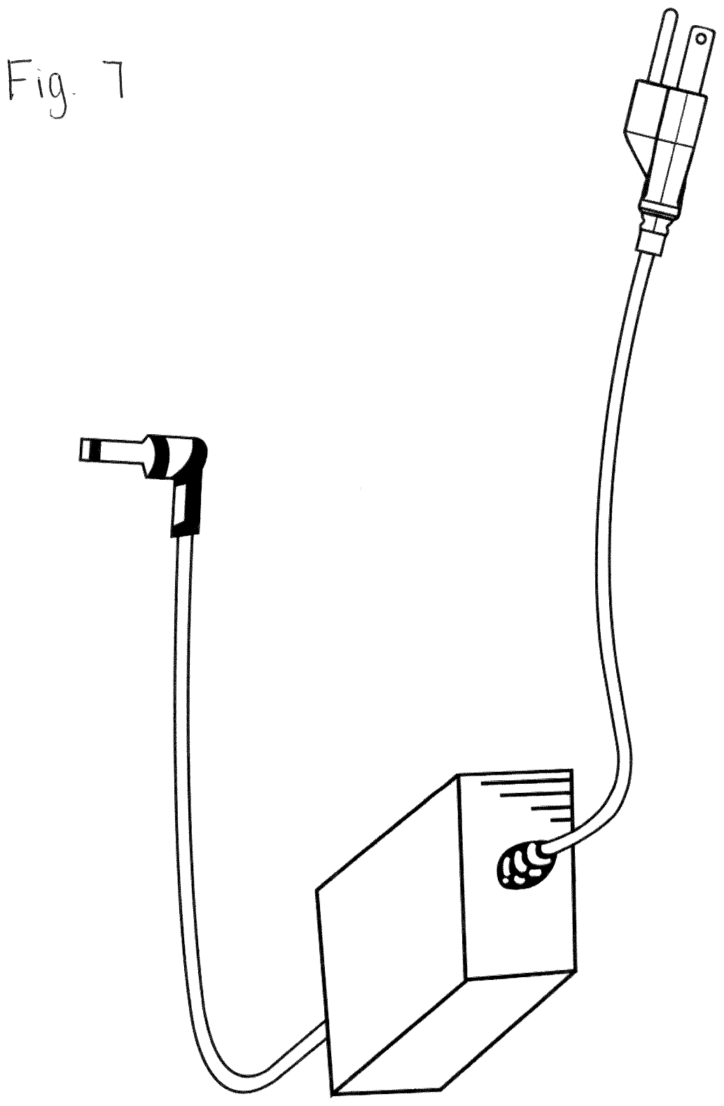

FIG. 7 Plug/Power Supply

### DESCRIPTION OF THE PREFERRED EMBODIMENTS

With reference now to Figures, and in particular with reference to FIG. 2 LED lights (1) power strips(2) to the LED lights. To FIGS. 5A,5B,6A and 6B side views (3) is made out of metal

1. I claim the ornamental design for the sugar skull shape LED lamp & sign as shown and described
